(19) United States
(12) Patent Application Publication
(10) Pub. No.: US 2016/0121811 A1
(43) Pub. Date: May 5, 2016

(54) ASSIST HANDLE FOR VEHICLE

(71) Applicant: DAEHAN SOLUTION CO., LTD, Incheon (KR)

(72) Inventors: Choong Ho KWON, Seoul (KR); Hyong-Jin KO, Incheon (KR)

(73) Assignee: DAEHAN SOLUTION CO., LTD, Incheon (KR)

(21) Appl. No.: 14/870,356

(22) Filed: Sep. 30, 2015

(30) Foreign Application Priority Data
Oct. 30, 2014 (KR) 10-2014-0148999

(51) Int. Cl. B60R 13/02

(52) U.S. Cl. CPC B60R 13/0212; B60R 2013/0287

(57) ABSTRACT

An assist handle for a vehicle, in which an elastically supported friction pin is mounted to a support bracket installed in a headlining and supporting a handle body by an elastic force of an elastic spring, and the friction pin may be always in contact with an inside face of a seat portion formed at the handle body in order that the friction pin may be rotatably installed in the support bracket, and thus the handle body may be allowed to smoothly rotate without abrupt rotation by generating a friction resistance due to the contact of the friction pin with the seat portion as the handle body is rotated relative to the support bracket.

### CROSS-REFERENCE TO RELATED APPLICATION

This application claims priority to and the benefit of Korean Patent Application No. 10-2014-0148999, filed on Oct. 30, 2014, the disclosure of which is incorporated herein by reference in its entirety.

### 1. FIELD OF THE INVENTION

The present invention relates to an assist handle for a vehicle, and more particularly, to an assist handle of a vehicle, in which a friction pin elastically supported in parallel with a hinge serving as a rotating center thereof is installed at a support bracket configured to rotatably support a handle body, and thus friction resistance is developed while the friction pin comes in contact with the handle body as a passenger uses the handle body, thereby reducing noise which may be generated while the elastically supported handle body collides with a headlining or the like, and improving actuation performance.

### 2. BACKGROUND OF THE INVENTION

Generally, assist handles are mounted at the tops of both sides of the interior of a vehicle such that a passenger may grasp one of them. The assist handle is rotatably mounted at a support bracket which is mounted to be positioned in the interior of the vehicle, i.e., at a lower portion of a border of the headlining. At this time, the assist handle is mounted to be in close contact with the headlining due to elastic support when it is not in use. In particular, in order to prevent noise from being generated when the assist handle collides with the headlining while returning into an original state due to such elastic support, the assist handle is configured to smoothly rotate by means of an oil damper. Patent documents 1 and 2 disclose a technical structure of the assist handle in which a handle body may smoothly rotate without an abrupt motion.

The patent document 1 provides an assist handle for a vehicle, in which a handgrip-shaped body is formed to be in close contact with a ceiling surface, and thus a pressure applied to a hand when a handgrip is used is relieved, and usability and ride quality are improved. As illustrated in FIG. 1, in the assist handle 10 for the vehicle, which is installed on a ceiling inside the vehicle to enhance ride quality of a passenger, both ends of the assist handle 10 are coupled with a ceiling surface by means of screws or the like. The assist handle 10 includes a base member 20 of which both side ends are connected through a connection portion 21; a handgrip 30 which has receiving portions 31 provided at both side ends of the base member 20 and a support groove 32 and a through-hole 33 formed at an inner side of the receiving portion 31; a hinge shaft 40 which is bearing-supported in such a way that the both side ends of the base member 20 are received and coupled into the receiving portion 31 of the handgrip 30 to be pivoted and which has a protrusion piece 42 formed at an inner end thereof; a spring 50 which is installed around the hinge shaft 40 such that the handgrip 30 which is bearing-supported on the base member by means of the hinge shaft 40 may be pivoted by a predetermined angle and then restored; and a damping member 60 which is configured to prevent rapid actuation by the spring 50 and to dampen an actuation speed thereof when the handle is restored by spring 50.

As illustrated in FIG. 2, an assist handle for a vehicle disclosed in the patent document 2 includes a connection member 10 of which both sides are fixed to a ceiling body panel 50 of a vehicle by a fastening screw 11; and a handgrip 20 which is adapted to be hingedly coupled to be in close contact with a roof trim 60 by being folded by an elastic spring 21 at both ends of the connection member 10 and to reduce a rotation force due to a viscous material at the time at which an oil damper 22 rotates together with the connection member 10 because the oil damper 22 combines with a journal box, thereby being smoothly folded, characterized in that, as a hole is formed at a center of the base member 12 formed at the both side ends of the connection member 10 to receive the fastening screw 11 such that an upper inner diameter d of the hole is less than an outer diameter of a screw thread of the fastening screw 11, the fastening screw 11 forms a screw thread on the upper inner diameter d of the hole while being assembled, thereby being capable of being fixed, and also an inner diameter t of a taper is formed such that the inner diameter d of the hole is gradually increased toward a lower side of the inner diameter d.

However, such a conventional assist handle has the following problems:

(1) The assist handle (auxiliary handgrip) is generally configured to be positioned in close contact with a headlining due to an elastic force of the elastic spring when the passenger do not use the assist handle. When the passenger uses the assist handle, the passenger uses the assist handle by rotating it in the headlining and then grasping it by a hand. However, if the passenger takes his hand off the assist handle, the assist handle rotates abruptly due to the elastic force of the elastic spring and collides with the headlining, thereby causing the noise generation.

(2) In order to solve this problem, like the patent documents 1 and 2, an oil damper is mounted to a conventional assist handle as a damping element for preventing abrupt actuation. However, the conventional oil damper may obtain a damping effect but oil leakage may be generated.

(3) In particular, there is a risk in that the oil damper may be easily damaged due to frequent actuation of the assist handle and thus the noise may be generated because the oil damper may not perform its function and thus the assist handle rotates abruptly and collides with the headlining when the oil leakage occurs.

(4) In addition, oil which leaks from the oil damper may fall to a floor of the interior of the vehicle. In this case, the oil which falls on a seat or a floor carpet, etc., may soil this area and may be a cause of aggravating an environment of the interior of the vehicle.

(5) Further, in the conventional oil damper, an actuating noise may be generated while oil passes through an orifice when the passenger turns the assist handle by the his/her hand to use it and the assist handle gets back to a original position. This may act as a noise.

(Patent document 1) Korean Utility Model Registration No. 20-0259434 published on Dec. 20, 2001

(Patent document 2) Korean Patent Application Publication No. 20-2008-0004679 published on Oct. 16, 2008

### SUMMARY OF THE INVENTION

The present invention is directed to provide an assist handle for a vehicle, in which an elastically supported friction pin is mounted to a support bracket installed in a headlining and supporting a handle body by an elastic force of an elastic spring, and the friction pin may be always in contact with an inside face of a seat portion formed at the handle body in order that the friction pin may be rotatably installed in the support bracket, and thus the handle body may be allowed to smoothly rotate without abrupt rotation by generating a friction resistance due to the contact of the friction pin with the seat portion as the handle body is rotated relative to the support bracket, and in particular, a simpler structure and thus easier fabrication may be allowed than the conventional oil damper, and also the problem originated from oil leakage may be prevented, because an oil source such as an oil damper is not used.

Also, the present invention is directed to provide an assist handle for a vehicle, in which by an actuation groove having a circular arc shape is formed at a seat portion along an actuation trajectory generated due to a contact of the friction pin with the seat portion as the handle body is rotated to use the assist handle, and thus a stopper function is performed at a position at which the assist handle is in use and at a position at which the assist handle is not in use and thus in contact with a headlining, while allowing the friction pin to move along a predefined trajectory.

Also, the present invention is directed to provide an assist handle for a vehicle, in which the actuation groove has a varying depth in such way that friction resistance of the friction pin may increase as the handle body is released from a hand which is holding the handle body, and thus as the handle body is received to be in contact with the headlining, the friction resistance of the friction pin may increase to prevent the handle body from rotating abruptly and also to reduce the noise due to smooth rotation.

According to an aspect of the present invention, there is provided an assist handle for a vehicle, including two support brackets (100) mounted at a headlining (H) to be spaced a predetermined distance; and a handle body (200) having seat portions (210) formed to receive and rotatably support the support brackets (100) at both ends thereof; wherein at least one of the support brackets (100) further includes a friction pin (110) which is elastically supported by an elastic spring (111); and the friction pin (110) is configured so that one end thereof protrudes toward an outside of the support bracket (100) to be supported by the elastic spring (111) and to be in contact with an inner surface of the seat portion (210), thereby causing friction resistance.

The assist handle for the vehicle may include an actuation groove (211) formed to have an arc shape at a region of the seat portion (210) which is in contact with the friction pin (110) as the handle body (200) is rotated.

The actuation groove (211) may be formed to deepen as the actuation groove (211) proceeds from a receipt depth (h) corresponding to a position facing the headlining (H) toward a withdrawal depth (h′) corresponding to a position in which the handle body (200) is rotated relative to the support bracket (100) to use the assist handle.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a representative view of a patent document 1;

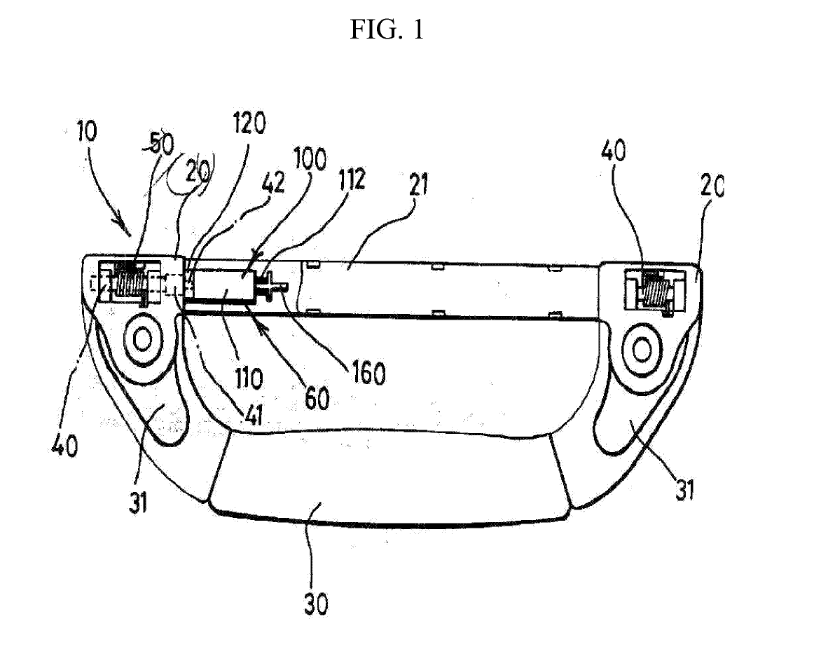

FIG. 2 is a drawing corresponding to FIG. 2 shown in a patent document 2;

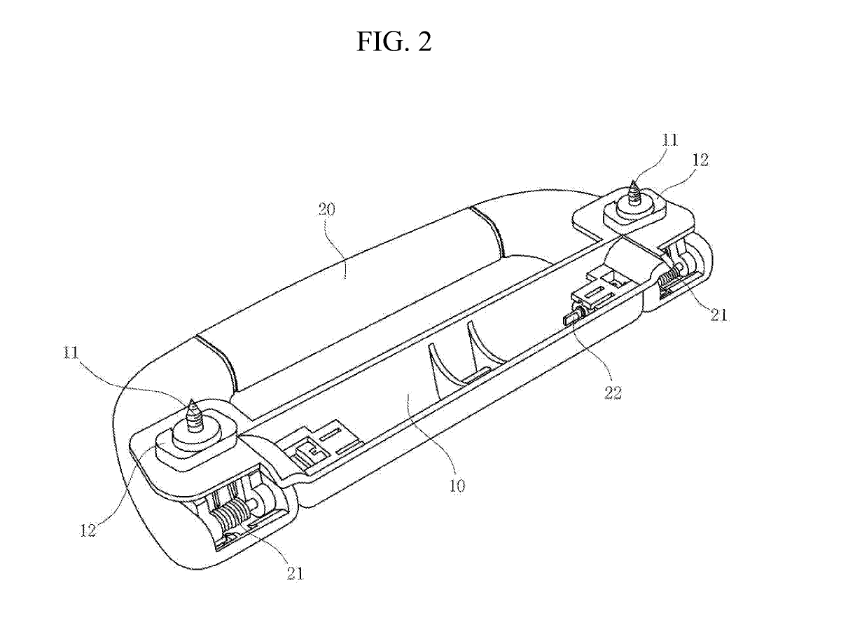

FIG. 3 is a bottom view illustrating one example of a headlining having an assist handle according to a first embodiment of the present invention;

FIG. 4 is a cross sectional view taken along a line “A-A” in FIG. 3 illustrating a mounted state of the assist handle according to the first embodiment of the present invention;

FIG. 5 is a perspective view illustrating a state in which a support bracket is separated from a handle body to show a structure of the assist handle according to the first embodiment of the present invention;

FIG. 6 is a partial perspective view illustrating a structure of a seat portion in a handle body of an assist handle according to a second embodiment of the present invention; and

FIG. 7 is a partial perspective view illustrating a structure of a seat portion in a handle body of an assist handle according to a third embodiment of the present invention.

### DETAILED DESCRIPTION OF MAIN ELEMENTS

100: support bracket
110: friction pin
111: elastic spring
120: hinge pin
200: handle body
210: seat portion
211, 211′: actuation groove
212: hinge hole

### DETAILED DESCRIPTION OF THE INVENTION

Exemplary embodiments of the present invention will be described in detail below with reference to the accompanying drawings. The terminology and words used in the specification and claims should not be interpreted as being limited to the general or lexical meaning and should be interpreted as the meaning and the concept in coincidence with the technical concept of the invention according to the principle that the inventor(s) may define appropriately the concept of the terminology in order to describe this invention in the best mode.

Therefore, as the embodiments described in the specification and the structures illustrated in the drawing correspond to simply one preferable embodiment and do not represent all the technical concept of the present invention, it should be understood that various equivalents and modifications which may substitute these may exist at the time of filing the present application.

### First Embodiment

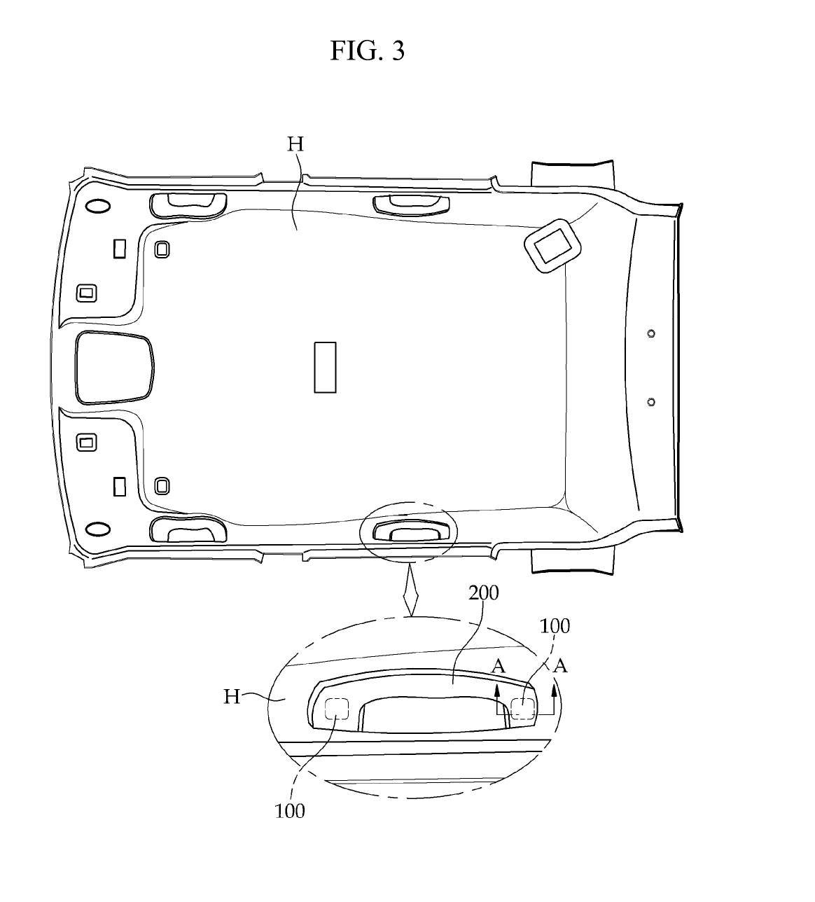

As shown in FIGS. 3 to 5, an assist handle of a vehicle according to a first embodiment of the present invention includes two support brackets 100 which are mounted at a headlining H, and a handle body 200 of which both sides are supported by the support brackets 100 to be rotatable.

In particular, at least one of the two support brackets 100 may include an elastically supported friction pin 110 and thus a friction resistance may be generated when the handle body 200 is rotated, and thus the handle body 200 which is elastically supported and rotated relative to the support brackets 100 may be prevented from being abruptly rotated and may be smoothly rotated.

Hereinafter, this structure will be described in greater detail below:

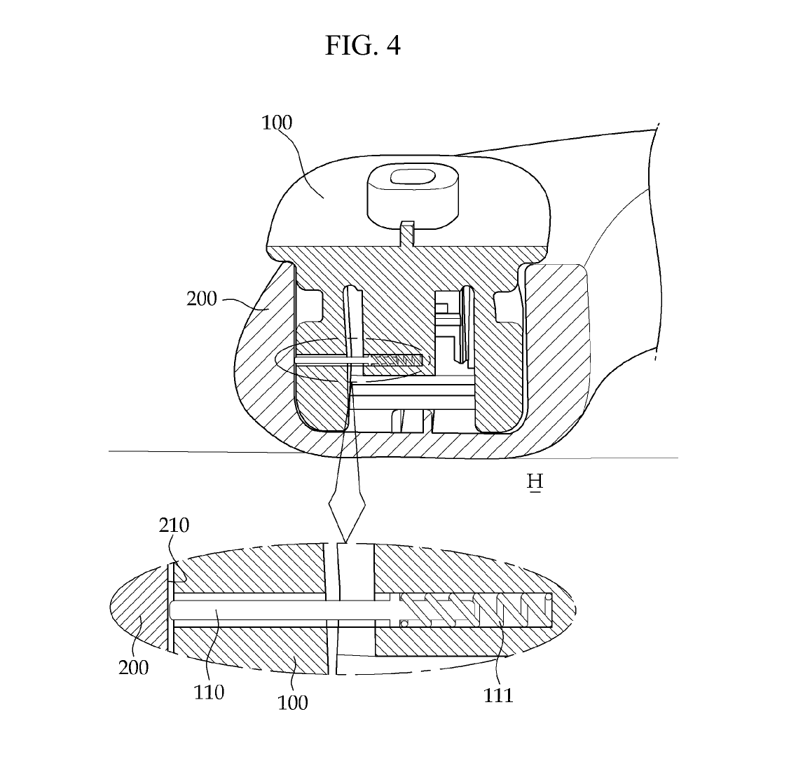

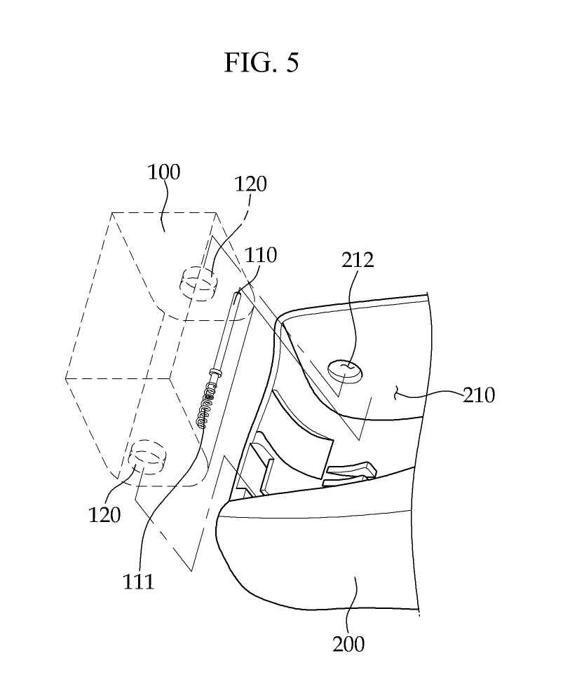

As shown in FIGS. 3 and 4, the support brackets 100 are mounted at the headlining H and serve to rotatably support the handle body 200 to be described later. The support brackets 100 may be configured in the form of a block to improve a rotation support force, as shown in FIGS. 4 and 5.

In addition, as shown in FIG. 5, the support brackets 100 have the hinge pins 120 formed at both sides thereof, respectively and thus each of the hinge pins serves as a rotational center of the handle body 200. In the preferable embodiment of the present invention, the hinge pins 120 are illustrated to protrude from the support bracket 100 in the form of a protrusion, but may be separately manufactured in the form of a shaft and then inserted into the support brackets 100 to fix the handle body 200.

Meanwhile, as shown in FIGS. 4 and 5, each of the support brackets 100 may further include a friction pin 110 which is supported by an elastic spring 111. In this case, the friction pin 110 is formed so that one side thereof protrudes toward an outside of the support bracket 100, while being elastically supported in the support bracket 100. The drawing shows an example in which the friction pin 110 is mounted at the support bracket 100 to be positioned in parallel with the hinge pin 120. In the preferable embodiment of the present invention, the friction pin 110 is described to be arranged in parallel with the hinge pin 120. However, the friction pin 110 may be arranged at any position where friction resistance is generated, for example, arranged perpendicularly to the hinge pin 120 or at a predetermined angle relative to the hinge pin 120. Here, for convenience of explanation, the case in which the friction pin 110 is installed in parallel with the hinge pin 120 is described by way of example.

As shown in FIGS. 4 and 5, in this case, the friction pin 110 is installed so that the end of friction pin 110 which protrudes toward the outside of the support bracket 100 is elastically supported by the elastic spring 111, while being always in contact with an inner face of a seat portion 210.

The handle body 200 may be generally formed to have a “ [symbol] ” shape, as shown in FIG. 3 and may have seat portions 210 formed at both sides thereof to surround the support bracket 100 as described above. At this time, the seat portions 210 may have hinge holes 212 formed at both opposite faces as shown in FIG. 5, and the hinge pins 120 are inserted into the hinge holes such that the handle body 200 may be rotatably mounted. Here, although not shown in the drawings, the handle body 200 is installed to be elastically supported by an elastic spring which provides an elastic force centering on the hinge pin 120. At this time, the handle body 200 is installed to be elastically supported centering on the hinge pin 120, and thus to have an elastic force which forces the handle body to always return toward the headlining H.

In a preferable embodiment of the present invention, even though the handle body 200 that is rotatably mounted at the support bracket 100, the seat portion 210 is rotated, the seat portion is formed not to cause rotation interference with the support bracket 100.

In addition, in a preferable embodiment of the present invention, the seat portion 210 is manufactured to form two surfaces which face each other, and in particular, to have a size that the friction pin 110 is always in contact with the two surfaces that face each other, even when the handle body 200 is rotated about the support bracket 100.

In the assist handle having this structure according to the present invention, the handle body 200 which is elastically supported by the spring not shown always keeps in close contact with the headlining H. In this state, the passenger uses the assist handle while grasping the handle body 200 and rotating it toward the interior of the vehicle.

Meanwhile, if the passenger releases the handle body 200 held by the hie/her hand, the handle body 200 is rotated to the headlining H due to the elastic force of the spring (not shown). At this time, the friction pin 110 comes in contact with the seat portion 210 while being elastically supported by a spring.

For this reason, since the handle body 200 has to overcome the elastic force of the rotation pin 110 and rotate toward the headlining H, a rotation speed is decreased due to an intensity of the friction resistance, and thus the handle body is prevented from being abruptly rotated.

### Second Embodiment

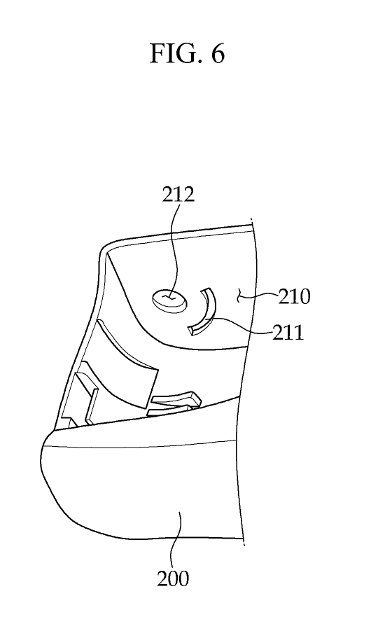

As shown in FIG. 6, an assist handle of a vehicle according to a second embodiment of the present invention further includes an actuation groove 211 in the seat portion 210, compared to the assist handle according to the first embodiment. Accordingly, parts that are the same as those of the first embodiment are given like reference numerals and the detailed description thereof will be omitted. For convenience of explanation, only the actuation groove 211 will be described here.

In the second embodiment, as shown in FIG. 6, the seat portion 210 is configured to further include the actuation groove 211. In this case, the actuation groove 211 is formed along a rotation trajectory of the friction pin 110 to have the circular arc shape.

That is, the seat portion 210 has the actuation groove 211 formed to have the circular arc shape having a predetermined length at a region of the seat portion which is in contact with the friction pin 110 with respect to the hinge pin 120, i.e., at the region thereof which is in contact with the friction pin 110 from a moment at which the handle body 200 is in contact with the headlining H to a moment at which the handle body 200 is completely rotated to use the assist handle.

The actuation groove 211 may allow the friction pin 110 to stably generate the friction resistance between the friction pin 110 and the seat portion 210 along a predetermined trajectory. In particular, the actuation groove 211 may allow the friction pin 110 to serve as a stopper to inform the passenger that a moment at which the friction pin 110 is located at both ends of the actuation groove 211 is either a state in which the handle body 200 is in contact with the headlining H or, on the contrary a state in which the assist handle is in use.

### Third Embodiment

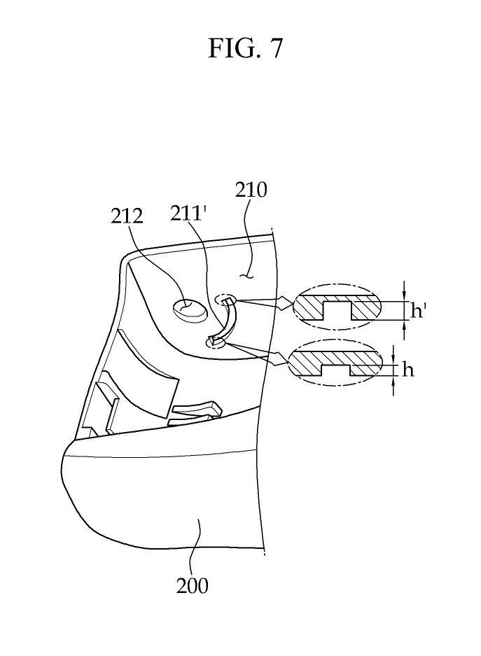

As shown in FIG. 7, an assist handle of a vehicle according to a third embodiment of the present invention includes an actuation groove 211′ having a varying depth, compared to the assist handle according to the second embodiment. Accordingly, parts that are the same as those of the second embodiment are given like reference numerals and the detailed description thereof will be omitted. For convenience of explanation, only the depth of the actuation groove 211′ will be described here.

In the third embodiment, as shown in FIG. 7, the actuation groove is formed to deepen as the actuation groove proceeds from a receipt depth h toward a withdrawal depth h′.

Here, the receipt depth h is a depth of the actuation groove 211′ at which the friction pin 110 is positioned when the handle body 200 is positioned to face the headlining H and thus the assist handle according to the present invention is not in use. The withdrawal depth h′ is a depth of the actuation groove 211′ in a state in which the handle body 200 is rotated toward the interior of the vehicle by the hand to use the assist handle according to the present invention.

At this time, the receipt depth h and the withdrawal depth h′ are positioned at both ends of the actuation groove 211′, respectively. In the present invention, as described above, the actuation groove 211′ is formed to deepen as the actuation groove 211′ proceeds from the receipt depth h toward the withdrawal depth h′.

In a preferable embodiment of the present invention, a depth difference between the receipt depth h and the withdrawal depth may be designed to have a cam curve shape. At this time, the cam curve may be designed in various forms, but by way of example, it is designed in an “S” shape in which high friction resistance is formed at a convex portion thereof and low friction resistance is formed at a concave portion thereof. In particular, since the friction resistance is changed along each curved surface portion of the concave portion and the convex portion, the assist handle may be actuated gently and smoothly.

Accordingly, an elastic support force of the friction pin 110 is weak at a deep point, and is strong at a shallow point. Therefore, the elastic support force of the friction pin 110 is gradually stronger as the handle body 200 is returned toward the headlining H than when the handle body 200 is in use. This acts as a friction against the elastic force to return the handle body 200 to the original position, thereby preventing the handle body 200 from moving abruptly and allowing the handle body to rotate smoothly.

The assist handle for a vehicle according to the present invention has the following effects.

(1) Since the abrupt rotation of the handle body can be prevented using the elastic spring and the friction pin, the structure assist handle can have a simple structure, and can be easily manufactured.

(2) In particular, since the present invention can prevent the abrupt rotation of the handle body and also can allow the handle body to rotate smoothly using a kinematic structure, the problem which may occur in the conventional assist handle using an oil damper, in particular, a phenomenon of the oil leakage can be fundamentally prevented.

(3) In addition, since the present invention is configured so that the friction force of the friction pin is applied in a direction perpendicular to a rotation direction of the handle body, this structure can not only increase a friction effect against the elastic force of the spring used for rotating the handle body but also cause a slip, and thus can allows the handle body to rotate smoothly.

(4) Meanwhile, by forming the actuation groove having the circular arc shape in the seat portion, which is in contact with the friction pin, along the contact trajectory of the friction pin, it is possible not only to cause an actuation in which the friction pin can be smoothly operated, but also to control the handle body to be actuated within a limited operation range.

(5) Further, by forming the actuation groove to have a varying depth in such a way that, as the handle body is rotated in a direction in which it comes in contact with the headlining, the friction pin can receive the stronger friction resistance, and the handle body can be prevented from abruptly colliding with the headlining, and thus the noise generation can be minimized.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An assist handle for a vehicle, comprising:
two support brackets mounted at a headlining (H) to be spaced a predetermined distance; and
a handle body having seat portions formed to receive and rotatably support the support brackets at both ends thereof;
wherein at least one of the support brackets further comprises a friction pin which is elastically supported by an elastic spring; and
the friction pin is configured so that one end thereof protrudes toward an outside of the support bracket to be supported by the elastic spring and to be in contact with an inner surface of the seat portion, thereby causing friction resistance.

2. The assist handle for the vehicle of claim 1, comprising an actuation groove formed to have an arc shape at a region of the seat portion which is in contact with the friction pin as the handle body is rotated.

3. The assist handle for the vehicle of claim 2, wherein the actuation groove is formed to deepen as the actuation groove proceeds from a receipt depth (h) corresponding to a position facing the headlining (H) toward a withdrawal depth (h′) corresponding to a position in which the handle body is rotated relative to the support bracket to use the assist handle.
